(19) United States
(12) Patent Application Publication
(10) Pub. No.: US 2025/0132381 A1
(43) Pub. Date: Apr. 24, 2025

(54) MIXED-ANION SOLID ELECTROLYTE AND PREPARATION METHOD AND USE THEREOF

(71) Applicant: HEFEI UNIVERSITY OF TECHNOLOGY, Anhui (CN)

(72) Inventors: Xuyong Feng, Anhui (CN); Liming Zhang, Anhui (CN); Hongfa Xiang, Anhui (CN)

(73) Assignee: HEFEI UNIVERSITY OF TECHNOLOGY, Anhui (CN)

(21) Appl. No.: 18/769,273

(22) Filed: Jul. 10, 2024

(30) Foreign Application Priority Data
Oct. 24, 2023 (CN) 202311388877.8

(51) Int. Cl. H01M 10/0562; C01F 7/78; C01G 17/00; C01G 33/00; C01G 35/00; C01G 39/00; C01G 41/00; H01M 10/0525

(52) U.S. Cl. CPC H01M 10/0562; C01F 7/78; C01G 17/006; C01G 33/006; C01G 35/006; C01G 39/006; C01G 41/006; H01M 10/0525; C01P 2002/50; C01P 2002/72; C01P 2002/86; C01P 2006/40; H01M 2300/0071; H01M 2300/008

(57) ABSTRACT

The invention relates to a mixed-anion solid electrolyte, having the following chemical formula: Li_{d}Al_{1-c}Y_{c}Cl₃₋ₐX_{b}, wherein Y is selected from at least one of Si⁴⁺, Ge⁴⁺, Sn⁴⁺, Sb⁵⁺, Nb⁵⁺, Ta⁵⁺, Mo⁶⁺, and W⁶⁺, and X is selected from at least one of O²⁻, S²⁻, F⁻, Br⁻, I⁻, and BH⁴⁻; and wherein 0<d≤2, 0<b≤2, 0<a≤2, 0<c<0.75 and charge balance is reached.

### CROSS-REFERENCE TO RELATED APPLICATION

This application claims the priority benefit of China application serial no. 202311388877.8, filed on Oct. 24, 2023. The entirety of the above-mentioned patent application is hereby incorporated by reference herein and made a part of this specification.

### BACKGROUND

### Technical Field

The invention relates to the technical field of solid electrolytes, and in particular to a mixed-anion solid electrolyte and a preparation method and use thereof.

### Description of Related Art

Since the organic electrolyte in traditional lithium-ion batteries is usually flammable and fluid, it is easy to volatilize, burn, and leak, which is accompanied by certain safety risks. Therefore, using non-flammable solid electrolytes with high elastic modulus instead of organic liquid electrolytes to construct all-solid-state lithium-ion batteries can not only avoid safety hazards caused by organic liquid electrolytes, but also prevent dendrites from piercing a separator and causing short circuits of batteries. In this way, safety issues of batteries can be addressed and it can also make lithium anodes possible, thereby increasing the energy density of batteries.

Solid electrolytes, as the main component of all-solid-state batteries, are crucial to the electrochemical performance and cost of batteries. Among solid electrolytes, halide solid electrolytes are considered to be the most promising candidates for solid electrolytes in high-voltage all-solid-state lithium-ion batteries due to their high ionic conductivity, excellent high voltage stability, and good electrode material compatibility. However, there are two major problems that hinder the commercialization of halide all-solid-state batteries: one is that the halide solid electrolytes are unstable to low-potential anodes and cannot match the low-potential anodes; at the same time, the halide solid electrolytes are unstable to air and easily react with water in the air; the other is that the cost of halide solid electrolytes is higher. On the one hand, since halide solid electrolytes usually contain precious rare earth elements, such as In³⁺, Y³⁺, Sc³⁺, the raw material cost is high. On the other hand, preparation of halide solid electrolytes often requires long-term ball milling, resulting in low efficiency and high preparation cost.

Using cheap Al³⁺ to replace precious rare earth elements can not only reduce the raw material cost of halide solid electrolytes, but also significantly reduce the reduction potential of halide solid electrolytes, making it possible to match low-potential anodes. However, the ionic conductivity of Al-based halide solid electrolytes is low and it is difficult to meet the requirements of solid electrolytes.

### SUMMARY

In view of this, in response to the problem that the ionic conductivity of Al-based halide solid electrolytes is low and it is difficult to meet the requirements of solid electrolytes, an objective of the invention is to provide a mixed-anion solid electrolyte and a preparation method and use thereof.

To achieve the above objective, the invention adopts the following technical solutions:

The invention provides a mixed-anion solid electrolyte, having the following chemical formula: Li_{d}Al_{1-c}Y_{c}Cl₃₋ₐX_{b}, wherein Y is selected from at least one of Si⁴⁺, Ge⁴⁺, Sn⁴⁺, Sb⁵⁺, Nb⁵⁺, Ta⁵⁺, Mo⁶⁺, and W⁶⁺, and X is selected from at least one of O²⁻, S²⁻, F⁻, Br⁻, I⁻, and BH⁴⁻; and wherein 0<d≤2, 0<b≤2, 0<a≤2, 0<c<0.75 and charge balance is reached.

A main method to improve the ionic conductivity of a solid electrolyte is to regulate its macro and micro structure, and adjust the potential energy of ions at different sites in the solid, thereby reducing the activation energy during ion migration and increasing the rate of ion migration between different sites. The potential energy of ions at different sites in the solid is mainly related to the surrounding chemical environment, including the type, distance and angle of the coordination ions. The closer the ions are, the greater the impact on their potential energy. For Li⁺, the nearest ions are generally anions such as O²⁻, X⁻, and S²⁻, and when the type and quantity of anions are changed, it will often greatly influence the potential energy of Li⁺ at the corresponding sites. For example, when Li ions (Li⁺) are situated in tetrahedral voids, the potential energy of Li⁺ is relatively low if surrounding coordination ions are S²⁻ ions, and if the coordination ions become X⁻ halogens, the potential energy of Li⁺ is relatively high. Therefore, the introduction of mixed anions, especially mixed anions, such as O²⁻/X⁻, O²⁻/S²⁻, and S²⁻/X⁻, can adjust the potential energy at different sites, which is beneficial to reducing the potential energy difference of Li⁺ in tetrahedral voids and the octahedral void, thereby reducing the activation energy of Li⁺ migration between the tetrahedral voids and the octahedral voids. In halide solid electrolytes, the migration of Li⁺ often occurs in a pattern of octahedral void-tetrahedral void-octahedral void, where the potential energy in tetrahedral voids is relatively high. The introduction of some O²⁻ or S²⁻ will help reduce the potential energy in tetrahedral voids, thereby reducing the activation energy of Li⁺ migration and improving the ionic conductivity. The thermodynamic stability of the solid electrolyte is further improved by metal cation mixing and it will help further increase the degree of anion mixing, thereby further reducing the activation energy of ion migration and improving the ionic conductivity.

In the invention, a chloride of Al is used as the main framework, Li ions are introduced into the structure by means of melting reaction, and at the same time a certain amount of sulfur ions (S²⁻), oxygen ions (O²⁻), fluoride ions (F⁻), bromide ions, (Br⁻), iodide ions (I⁻), borohydride ions (BH⁴⁻) and other anions are doped to replace some chloride ions (Cl⁻) to regulate the energy of Li ions at different sites. In this way, by increasing the energy of Li ions in the octahedral voids and reducing the energy of Li ions in the tetrahedral voids, Li ions are allowed to enter the tetrahedral voids of the crystal lattice to reduce the activation energy of Li⁺ migration, thereby significantly improving the ionic conductivity. In the meanwhile, by doping a certain amount of silicon ions (Si⁴⁺), germanium ions (Ge⁴⁺), tin ions (Sn⁴⁺), antimony ions (Sb⁵⁺), niobium ions (Nb⁵⁺), tantalum ions (Ta⁵⁺), molybdenum ions (Mo⁶⁺), tungsten ions (W⁶⁺) and other cations to replace some Al ions (Al³⁺), the concentration of Li ions in the solid electrolyte and the thermodynamic stability of the electrolyte are adjusted, more anions are doped, and the ionic conductivity is further improved.

As a further improvement of the above solution of the invention, based on a molar ratio, the replacement of Cl⁻ in AlCl₃ by the anions is within a range of 1% to 50%, preferably 20% to 50%.

As a further improvement of the above solution of the invention, the Y is selected from one of Si⁴⁺, Ge⁴⁺, Sn⁴⁺, Sb⁵⁺, Nb⁵⁺, Ta⁵⁺, Mo⁶⁺, and W⁶⁺.

As a further improvement of the above solution of the invention, the X is selected from one or two of O²⁻, S²⁻, F⁻, Br⁻, I⁻, and BH⁴⁻. Preferably, the X is selected from O²⁻ and/or S². In AlCl₃, Li ions usually only occupy normal octahedral sites. The introduction of O²⁻ and S²⁻ allows some Li ions to occupy metastable tetrahedral positions, thereby reducing the distance and energy required for Li ion migration and reaching the purpose of improving ionic conductivity. Moreover, the doping of oxygen element effectively ameliorates the weakness of poor low-voltage stability of halide solid electrolytes and improves the stability of halide solid electrolytes relative to lithium.

As a further improvement of the above solution of the invention, the chemical formula of the mixed-anion solid electrolyte is one of Li_{0.8}AlCl_{2.2}O_{0.8}, LiAlCl₂S_{0.5}O_{0.5}, Li_{0.8}AlCl_{1.8}O_{0.8}Br_{0.4}, Li_{0.8}AlCl_{1.8}O_{0.8}(BH₄)_{0.4}, Li_{0.8}AlCl_{1.8}O_{0.8}F_{0.4}, Li_{0.8}Al_{0.9}Nb_{0.1}Cl₂O, Li_{0.8}Al_{0.9}Ta_{0.1}Cl₂O, Li_{0.7}Al_{0.9}Mo_{0.1}Cl₂O, Li_{0.7}Al_{0.9}W_{0.1}Cl₂O, Li_{0.8}Al_{0.6}Si_{0.4}Cl_{2.2}O, Li_{0.9}Al_{0.9}Ge_{0.1}Cl₂O, and Li_{0.8}Al_{0.6}Nb_{0.2}Ta_{0.2}Cl_{2.2}O_{1.2}.

The invention further provides a preparation method of the mixed-anion solid electrolyte as described above, comprising the following steps: in an inert atmosphere, mixing AlCl₃, LiCl or LiOH, a lithium compound containing an X element, an aluminum compound containing an X element, and a chloride of a Y according to a stoichiometric ratio, and then well grinding the raw materials until no granules are observed; then, performing high-temperature reaction and cooling the reaction product to obtain the mixed-anion solid electrolyte.

In the invention, the mixed-anion solid electrolyte can be prepared by one-step high-temperature heat treatment and the heat treatment temperature is low, so the preparation cost is low. Specifically, the doped AlCl₃ is synthesized by a melting method, and Li⁺, transition metal cations and other anions are introduced at the same time. Under the action of mixed anions, Li ions (Li⁺) not only occupy the octahedral voids, which are normal sites, but also occupy, in part, the metastable tetrahedral positions. The increase in distribution sites of Li⁺ will shorten the distance of ion migration, thereby reducing activation energy of ion migration and increasing the conductivity of Li⁺. Because of Li⁺ at these tetrahedral sites, the ionic conductivity of the Al-based mixed-anion solid electrolyte is several orders of magnitude higher than that of LiAlCl₄, and its ionic conductivity can reach up to 10⁻³ S/cm, thereby effectively improving the use of halide solid electrolytes in all-solid-state lithium metal batteries and improving the performance of all-solid-state lithium metal batteries.

In the specific preparation method of the invention using the melting method to prepare the mixed-anion solid electrolyte, raw materials, treatment temperatures, time, etc. may vary according to the composition of products.

As a further improvement of the above solution of the invention, the lithium compound containing an X element is at least one of LiF, LiBr, Lil, Li₂O, Li₂S, and LiBH₄.

As a further improvement of the above solution of the invention, the aluminum compound containing an X element is at least one of AlBr₃, AlF₃, AlI₃, Al(OH)₃, and Al₂O₃.

As a further improvement of the above solution of the invention, the chloride of a Y element is at least one of SiCl₄, SiCl₂O, GeCl₄, SnCl₄, NbCl₅, WCl₆, and MoCl₆.

As a further improvement of the above solution of the invention, a temperature rise rate of the high-temperature reaction is within a range of 1° C./min to 5° C./min.

As a further improvement of the above solution of the invention, a reaction temperature of the high-temperature reaction is not lower than 150° C. Preferably, the reaction temperature of the high-temperature reaction is within a range of 150° C. to 400° C. More preferably, the reaction temperature of the high-temperature reaction is 200° C.

As a further improvement of the above solution of the invention, a reaction time of the high-temperature reaction is not less than 30 min. Preferably, the reaction time of the high-temperature reaction is within a range of 0.1 h to 2 h. More preferably, the reaction time of the high-temperature reaction is 2 h.

It can be understood that in the preparation method described above, the inert atmosphere has the same meaning and refers to at least one of rare gases (i.e., at least one of element gases of the 0 group, such as helium and argon) or nitrogen. It may be selected according to the needs of those skilled in the art and will not be described here in detail.

The invention further provides a use of the mixed-anion solid electrolyte as described above or the mixed anion solid electrolyte prepared by the preparation method as described above in the preparation of a lithium-ion battery.

The invention further provides an all-solid-state lithium-ion battery, comprising a solid electrolyte. The solid electrolyte is the mixed-anion solid electrolyte as described above or the mixed-anion solid electrolyte prepared by the preparation method as described above. It can be understood that the lithium-ion solid electrolyte further comprises a cathode, an anode, etc., which all can use conventional lithium-ion battery materials in the art, so they will not be described in detail here. Since the lithium-ion halide solid-state electrolyte described herein has excellent ionic conductivity, the all-solid-state lithium-ion battery assembled from it has excellent cycling performance and rate performance.

Compared with the prior art, the invention has the following beneficial effects.
1. In the invention, a chloride of Al is used as the main framework, Li ions are introduced into the structure by means of melting reaction, and at the same time a certain amount of sulfur ions (S²⁻), oxygen ions (O²⁻), fluoride ions (F⁻), bromide ions, (Br⁻), iodide ions (I⁻), borohydride ions (BH⁴⁻) and other anions are doped to replace some chloride ions (Cl⁻) to regulate the energy of Li ions at different sites. In this way, by increasing the energy of Li ions in the octahedral voids and reducing the energy of Li ions in the tetrahedral voids, Li ions are allowed to enter the tetrahedral voids of the crystal lattice to reduce the activation energy of Li⁺ migration, thereby significantly improving the ionic conductivity. In the meanwhile, by doping a certain amount of silicon ions (Si⁴⁺), germanium ions (Ge⁴⁺), tin ions (Sn⁴⁺), antimony ions (Sb⁵⁺), niobium ions (Nb⁵⁺), tantalum ions (Ta⁵⁺), molybdenum ions (Mo⁶⁺), tungsten ions (W⁶⁺) and other cations to replace some Al ions (Al³⁺), the concentration of Li ions in the solid electrolyte and the thermodynamic stability of the electrolyte are adjusted, more anions are doped, and the ionic conductivity is further improved.
2. In the invention, based on the strategy of improving the conductivity of halide solid electrolytes by anion mixing, a simple preparation method and low cost are achieved, and by doping new anions to form an anion mixing system, additional Li ion-occupied sites are provided for the new structure, crystal microstructure and Li ion distribution can be adjusted, and activation energy of ion migration can be reduced, thereby promoting Li ion transport. Partial anion doping can expand the electrochemical stability window of the electrolyte and improve the electrochemical stability between the solid electrolyte and lithium as well as the high-potential cathode.
3. In the invention, by doping trivalent Al ions with high-valent cations, it helps increase the doping concentration of anions, thereby further improves the ionic conductivity of the electrolyte. To maintain charge conservation, Li ion vacancies are introduced, thereby reducing the use of lithium and lowering the cost.
4. The conductivity of the solid electrolyte of the invention and the stability of Li ion are significantly improved, which can effectively improve the use of halide solid electrolytes in all-solid-state lithium metal batteries and improve the performance of all-solid-state lithium metal batteries.

### BRIEF DESCRIPTION OF THE DRAWINGS

FIG. 1 is an impedance diagram of mixed-anion solid electrolytes of Examples 1-2, 6, 10, and 12 of the invention.

FIG. 2 shows NMR spectra of Li_{0.8}AlCl_{2.2}O_{0.8} of Example 1 of the invention and LiAlCl₄ of Comparative Example 2.

FIG. 3 is an XRD pattern of the mixed-anionic solid electrolytes in FIG. 1.

FIG. 4 is a schematic diagram of the electrical conductivity of different cation doped samples.

FIG. 5 shows cyclic voltammetry curves of the lithium-ion halide solid electrolyte Li_{0.8}AlCl_{2.2}O_{0.8} in Example 1 of the invention.

FIG. 6 is a schematic diagram of a LACO+LCO/LACO/LPSC/Li—In all-solid-state battery assembled in a test example of the invention.

FIG. 7 shows cycling performance test results of the LACO+LCO/LACO/LPSC/Li—In all-solid-state battery in FIG. 6.

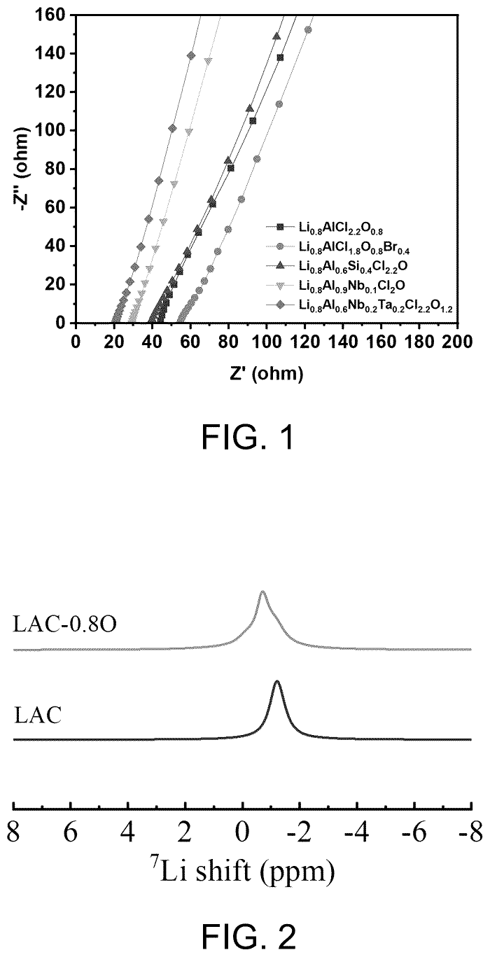

### DESCRIPTION OF THE EMBODIMENTS

The technical solutions in the embodiments of the invention will be described clearly and completely below in connection with the drawings in the embodiments of the invention, and it will be apparent that the embodiments described here are only some, but not all of the embodiments of the invention. All other embodiments obtained by a person of ordinary skill in the art based on the embodiments of the invention without creative efforts shall fall within the scope of the invention.

### Example 1

This embodiment provides a mixed-anion solid electrolyte, having a chemical formula of Li_{0.8}AlCl_{2.2}O_{0.8}, and its preparation method comprises the following steps.

In an argon-filled glove box with a water and oxygen content of less than 0.1 ppm, LiOH and AlCl₃, with a molar ratio of 0.8:1, were ground manually in a mortar for about 10 min until LiOH and AlCl₃ were well mixed and no granules were observed. The mixture was transferred to a quartz tube and sealed. The mixture was then heated to 200° C. at a temperature rise rate of 5° C./min and held at this temperature for 2 h to obtain Li_{0.8}AlCl_{2.2}O_{0.8}.

### Example 2

This embodiment provides a mixed-anion solid electrolyte, having a chemical formula of Li_{0.8}AlCl_{1.8}O_{0.8}Br_{0.4}, and its preparation method comprises the following steps.

In an argon-filled glove box with a water and oxygen content of less than 0.1 ppm, LiOH, AlCl₃ and AlBr₃, with a molar ratio of 4:3:2, were ground manually in a mortar for about 10 min until LiOH, AlCl₃ and AlBr₃ were well mixed and no granules were observed. The mixture was transferred to a quartz tube and sealed. The mixture was then heated to 200° C. at a temperature rise rate of 5° C./min and held at this temperature for 1 h to obtain Li_{0.8}AlCl_{1.8}O_{0.8}Br_{0.4}.

### Example 3

This embodiment provides a mixed-anion solid electrolyte, having a chemical formula of Li_{0.8}AlCl_{1.8}O_{0.8}(BH₄)_{0.4}, and its preparation method comprises the following steps.

In an argon-filled glove box with a water and oxygen content of less than 0.1 ppm, LiOH, LiBH₄, AlCl₃ and Al(OH)₃, with a molar ratio of 6:6:13:2, were ground manually in a mortar for about 10 min until LiOH, LiBH₄, AlCl₃ and Al(OH)₃ were well mixed and no granules were observed. The mixture was transferred to a quartz tube and sealed. The mixture was then heated to 200° C. at a temperature rise rate of 5° C./min and held at this temperature for 2 h to obtain Li_{0.8}AlCl_{1.8}O_{0.8}(BH₄)_{0.4}.

### Example 4

This embodiment provides a mixed-anion solid electrolyte, having a chemical formula of LiAlCl₂S_{0.5}O_{0.5}, and its preparation method comprises the following steps.

In an argon-filled glove box with a water and oxygen content of less than 0.1 ppm, Li₂S, AlCl₃ and Al(OH)₃, with a molar ratio of 3:5:1, were ground manually in a mortar for about 10 min until LiOH and AlCl₃ were well mixed and no granules were observed. The mixture was transferred to a quartz tube and sealed. The mixture was then heated to 200° C. at a temperature rise rate of 5° C./min and held at this temperature for 2 h to obtain LiAlCl₂S_{0.5}O_{0.5}.

### Example 5

This embodiment provides a mixed-anion solid electrolyte, having a chemical formula of Li_{0.8}AlCl_{1.8}O_{0.8}F_{0.4}, and its preparation method comprises the following steps.

In an argon-filled glove box with a water and oxygen content of less than 0.1 ppm, LiOH, AlCl₃ and AlF₃, with a molar ratio of 12:13:2, were ground manually in a mortar for about 10 min until LiOH, AlCl₃ and AlF₃ were well mixed and no granules were observed. The mixture was transferred to a quartz tube and sealed. The mixture was then heated to 200° C. at a temperature rise rate of 5° C./min and held at this temperature for 2 h to obtain Li_{0.8}AlCl_{1.8}O_{0.8}F_{0.4}.

### Example 6

This embodiment provides a mixed-anion solid electrolyte, having a chemical formula of Li_{0.8}Al_{0.9}Nb_{0.1}Cl₂O, and its preparation method comprises the following steps.

In an argon-filled glove box with a water and oxygen content of less than 0.1 ppm, LiCl, AlCl₃, Al(OH)₃ and NbCl₅, with a molar ratio of 24:17:10:3, were ground manually in a mortar for about 10 min until LiCl, AlCl₃, Al(OH)₃ and NbCl₅ were well mixed and no granules were observed. The mixture was transferred to a quartz tube and sealed. The mixture was then heated to 150° C. at a temperature rise rate of 5° C./min and held at this temperature for 2 h to obtain Li_{0.8}Al_{0.9}Nb_{0.1}Cl₂O.

### Example 7

This embodiment provides a mixed-anion solid electrolyte, having a chemical formula of Li_{0.8}Al_{0.9}Ta_{0.1}Cl₂O, and its preparation method comprises the following steps.

In an argon-filled glove box with a water and oxygen content of less than 0.1 ppm, LiCl, AlCl₃, Al(OH)₃ and TaCl₅, with a molar ratio of 24:17:10:3, were ground manually in a mortar for about 10 min until LiCl, AlCl₃, Al(OH)₃ and TaCl₅ were well mixed and no granules were observed. The mixture was transferred to a quartz tube and sealed. The mixture was then heated to 180° C. at a temperature rise rate of 5° C./min and held at this temperature for 2 h to obtain Li_{0.8}Al_{0.9}Ta_{0.1}Cl₂O.

### Example 8

This embodiment provides a mixed-anion solid electrolyte, having a chemical formula of Li_{0.7}Al_{0.9}Mo_{0.1}Cl₂O, and its preparation method comprises the following steps.

In an argon-filled glove box with a water and oxygen content of less than 0.1 ppm, LiCl, AlCl₃, Al(OH)₃ and MoCl₆, with a molar ratio of 21:17:10:3, were ground manually in a mortar for about 10 min until LiCl, AlCl₃, Al(OH)₃ and MoCl₆ were well mixed and no granules were observed. The mixture was transferred to a quartz tube and sealed. The mixture was then heated to 200° C. at a temperature rise rate of 5° C./min and held at this temperature for 2 h to obtain Li_{0.7}Al_{0.9}Mo_{0.1}Cl₂O.

### Example 9

This embodiment provides a mixed-anion solid electrolyte, having a chemical formula of Li_{0.7}Al_{0.9}W_{0.1}Cl₂O, and its preparation method comprises the following steps.

In an argon-filled glove box with a water and oxygen content of less than 0.1 ppm, LiCl, AlCl₃, Al(OH)₃ and WCl₆, with a molar ratio of 21:17:10:3, were ground manually in a mortar for about 10 min until LiCl, AlCl₃, Al(OH)₃ and WCl₆ were well mixed and no granules were observed. The mixture was transferred to a quartz tube and sealed. The mixture was then heated to 200° C. at a temperature rise rate of 5° C./min and held at this temperature for 2 h to obtain Li_{0.7}Al_{0.9}W_{0.1}Cl₂O.

### Example 10

This embodiment provides a mixed-anion solid electrolyte, having a chemical formula of Li_{0.8}Al_{0.6}Si_{0.4}Cl_{2.2}O, and its preparation method comprises the following steps.

In an argon-filled glove box with a water and oxygen content of less than 0.1 ppm, LiOH, AlCl₃, Al(OH)₃ and SiCl₄, with a molar ratio of 12:8:1:6, were ground manually in a mortar for about 10 min until LiOH, AlCl₃, Al(OH)₃ and SiCl₄ were well mixed and no granules were observed. The mixture was transferred to a quartz tube and sealed. The mixture was then heated to 200° C. at a temperature rise rate of 5° C./min and held at this temperature for 2 h to obtain Li_{0.8}Al_{0.6}Si_{0.4}Cl_{2.2}O.

### Example 11

This embodiment provides a mixed-anion solid electrolyte, having a chemical formula of Li_{0.9}Al_{0.9}Ge_{0.1}Cl₂O, and its preparation method comprises the following steps.

In an argon-filled glove box with a water and oxygen content of less than 0.1 ppm, LiCl, AlCl₃, Al(OH)₃ and GeCl₄, with a molar ratio of 27:17:10:3, were ground manually in a mortar for about 10 min until LiCl, AlCl₃, Al(OH)₃ and GeCl₆ were well mixed and no granules were observed. The mixture was transferred to a quartz tube and sealed. The mixture was then heated to 200° C. at a temperature rise rate of 5° C./min and held at this temperature for 2 h to obtain Li_{0.9}Al_{0.9}Ge_{0.1}Cl₂O.

### Example 12

This embodiment provides a mixed-anion solid electrolyte, having a chemical formula of Li_{0.8}Al_{0.6}Nb_{0.2}Ta_{0.2}Cl_{2.2}O_{1.2}, and its preparation method comprises the following steps.

In an argon-filled glove box with a water and oxygen content of less than 0.1 ppm, LiOH, AlCl₃, Al(OH)₃, NbCl₅ and TaCl₅, with a molar ratio of 12:7:2:3:3, were ground manually in a mortar for about 10 min until LiOH, AlCl₃, Al(OH)₃, NbCl₅ and TaCl₅ were well mixed and no granules were observed. The mixture was transferred to a quartz tube and sealed. The mixture was then heated to 200° C. at a temperature rise rate of 5° C./min and held at this temperature for 2 h to obtain Li_{0.8}Al_{0.6}Nb_{0.2}Ta_{0.2}Cl_{2.2}O_{1.2}.

### Comparative Example 1

This embodiment provides a solid electrolyte, having a chemical formula of Li₃OCl, and its preparation method comprises the following steps.

In an argon-filled glove box with a water and oxygen content of less than 0.1 ppm, LiCl and Li₂O, with a molar ratio of 1:1, were ground manually in a mortar at room temperature for about 10 min until LiCl and Li₂O were well mixed and no granules were observed. The mixture was transferred to a ZrO₂ ball mill jar and sealed. The mixture was then ball milled in a planetary ball mill at a speed of 550 rpm for 20 h to obtain Li₃OCl.

### Comparative Example 2

This embodiment provides a solid electrolyte, having a chemical formula of LiAlCl₄, and its preparation method comprises the following steps.

In an argon-filled glove box with a water and oxygen content of less than 0.1 ppm, LiCl and AlCl₃, with a molar ratio of 1:1, were ground manually in a mortar at room temperature for about 10 min until LiCl and AlCl₃ were well mixed and no granules were observed. The mixture was transferred to a ZrO₂ ball mill jar and sealed. The mixture was then ball milled in a planetary ball mill at a speed of 550 rpm for 20 h to obtain LiAlCl₄.

### Test Example 1

### 1. Electrochemical Impedance Spectroscopy (EIS) and Activation Energy Testing

EIS and activation energy test were performed on the solid electrolytes of Examples 1-12 and Comparative Examples 1-2 respectively. The test methods were as follows.

0.2 g of solid electrolyte sample powder was placed in a polytetrafluoroethylene mold with a diameter of 12 mm and pressed into a tablet. Stainless steel current collectors were mounted at two ends and sealed with sealant to isolate the electrolyte from air. The above operations were all done in the presence of argon. The Biologic electrochemical workstation was used to measure the EIS of the electrolyte at different temperatures. The conductivity and activation energy were then calculated according to the impedance of the electrolyte. The test results are shown in Table 1.

TABLE 1

| | | | Activation |
|---|---|---|---|
| | | Conductivity | energy |
| Group | Sample | (S/cm) | (eV) |
| Example 1 | Li_{0.8}AlCl_{2.2}O_{0.8} | 1.63 × 10⁻³ | 0.302 |
| Example 2 | Li_{0.8}AlCl_{1.8}O_{0.8}Br_{0.4} | 1.35 × 10⁻³ | 0.330 |
| Example 3 | Li_{0.8}AlCl_{1.8}O_{0.8}(BH₄)_{0.4} | 0.76 × 10⁻³ | 0.380 |
| Example 4 | LiAlCl₂S_{0.5}O_{0.5} | 1.83 × 10⁻³ | 0.295 |
| Example 5 | Li_{0.8}AlCl_{1.8}O_{0.8}F_{0.4} | 0.53 × 10⁻³ | 0.379 |
| Example 6 | Li_{0.8}Al_{0.9}Nb_{0.1}Cl₂O | 2.53 × 10⁻³ | 0.287 |
| Example 7 | Li_{0.8}Al_{0.9}Ta_{0.1}Cl₂O | 2.24 × 10⁻³ | 0.298 |
| Example 8 | Li_{0.7}Al_{0.9}Mo_{0.1}Cl₂O | 1.93 × 10⁻³ | 0.322 |
| Example 9 | Li_{0.7}Al_{0.9}W_{0.1}Cl₂O | 1.74 × 10⁻³ | 0.3241 |
| Example 10 | Li_{0.8}Al_{0.6}Si_{0.4}Cl_{2.2}O | 1.95 × 10⁻³ | 0.292 |
| Example 11 | Li_{0.9}Al_{0.9}Ge_{0.1}Cl₂O | 1.59 × 10⁻³ | 0.336 |
| Example 12 | Li_{0.8}Al_{0.6}Nb_{0.2}Ta_{0.2}Cl_{2.2}O_{1.2} | 3.11 × 10⁻³ | 0.279 |
| Comparative | Li₃OCl | 0.007 × 10⁻³ | 0.643 |
| Example 1 | | | |
| Comparative | LiAlCl₄ | 0.02 × 10⁻³ | 0.580 |
| Example 2 | | | |

It can be seen from the test results in Table 1 that, compared with the electrolyte without anion or cation doping in Comparative Example 1-2, the halide electrolytes prepared in Examples 1-12 is improved by an order of magnitude in terms of conductivity and has the activation energy of Li ion migration reduced significantly, indicating that the energy of Li ions at different sites can be effectively controlled through anion and cation doping, and this is conductive to the migration of Li ions.

The schematic diagram of the conductivity of different cation-doped samples of the invention is shown in FIG. 4. It can be seen from FIG. 4 that cation doping can further improve the conductivity of the electrolyte. It indicates that on the basis of anion doping, cations replace some Al ions (Al³⁺), which can adjust the concentration of Li ions in the solid electrolyte and the thermodynamic stability of the electrolyte, thereby achieve the doping of more anions and further improving the ionic conductivity.

### 2. Structure Test of Electrolytes

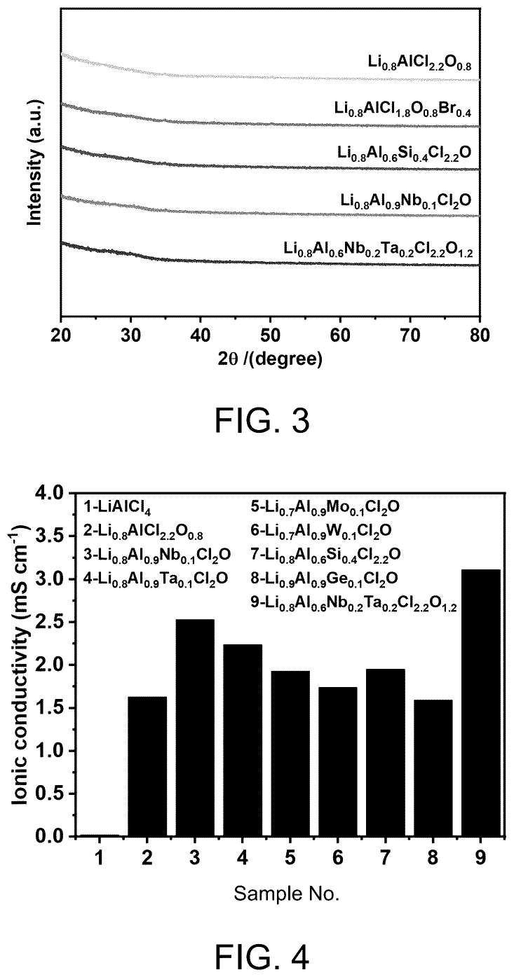

Solid-state MRI and X⁻ ray diffraction (XRD) tests were performed on halide solid electrolytes of different compositions in a typical example of the invention, and the results are shown in FIGS. 2 and 3. Referring to FIG. 2, without O ion doping, there is only one kind of Li ion in LiAlCl₄, and its occupied sites are octahedral voids. By doping some O ions, some Li ions can occupy other sites, such as tetrahedral voids, indicating that the doping of O ions does change the potential energy of Li ions at different sites. It can be seen from FIG. 3 that the halide solid electrolyte is in an amorphous state.

### 3. Electrochemical Window Test

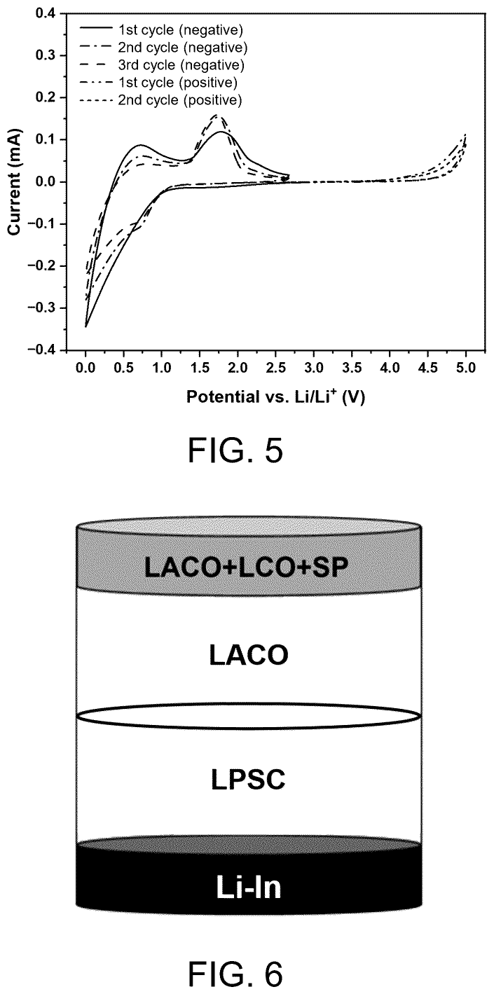

The solid electrolyte Li_{0.8}AlCl_{2.2}O_{0.8} prepared in Example 1 and a conductive agent SP were mixed at a mass ratio of 3:7. Using 0.01 g of the resulting mixture as a cathode, a lithium tablet as an anode, and 0.14 g of the solid electrolyte Li_{0.8}AlCl_{2.2}O_{0.8} prepared in Example 1 as an electrolyte layer, a battery was assembled for cyclic voltammetry scanning (0-5V, 0.5 mV/S). The results are shown in FIG. 5.

It can be seen from the test results in FIG. 5 that the halide electrolyte Li_{0.8}AlCl_{2.2}O_{0.8} prepared in Example 1 can be used together with a commonly used cathode material to assemble a battery, and the obtained battery also has excellent cycling performance and rate performance.

### 4. Assembly and Testing of a Battery

Li_{0.8}AlCl_{2.2}O_{0.8} prepared in Example 1 was used as a lithium-ion halide solid electrolyte to assemble a battery. The specific steps are as follows.

Preparation of a cathode: cathode active materials LiCoO₂, Li_{0.8}AlCl_{2.2}O_{0.8} (LACO) and the conductive agent SP were mixed at a mass ratio of 7:3:0.5, and the mixture was transferred to a stainless steel ball mill jar and then ball milled in a planetary ball mill at a speed of 200 rpm for 30 min to obtain a cathode powder.

Preparation of an anode: a lithium tablet and an indium tablet were laminated and pressed on a tablet press at a pressure of 20 Mpa for 10 h to obtain a Li—In alloy anode.

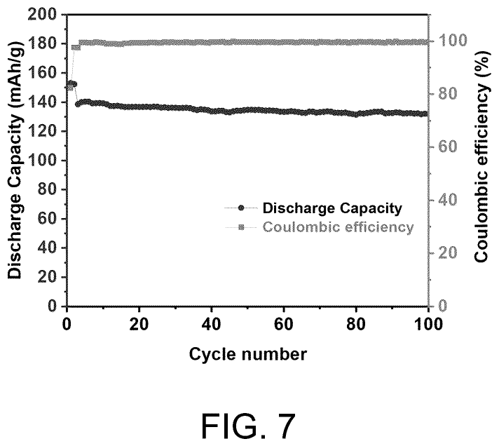

Assembly of a battery: the mixture of LiCoO₂, Li_{0.8}AlCl_{2.2}O_{0.8} (LACO) (Example 1) and the conductive agent SP serving as a cathode, the Li—In alloy serving as an anode, and LACO and Li₆PS₅Cl (LPSC) serving as an electrolyte were separately pressed into tablets in a polytetrafluoroethylene mold with a diameter of 12 mm and then assembled into a LACO+LCO/LACO/LPSC/Li—In all-solid-state battery, as shown in FIG. 6. The battery was tested for cycling performance at a rate of 0.5 C at room temperature. The test results are shown in FIG. 7.

It can be seen from the test results in FIG. 7 that after 100 cycles at a rate of 0.5 C, the capacity of the LACO+LCO/LACO/LPSC/Li—In all-solid-state battery remains 91% and the Coulombic efficiency remains 99% or above, indicating that the Al-based halide solid electrolyte has good high-voltage stability and can match the high-potential cathode to achieve good cycling performance and rate performance.

Unless otherwise defined, all technical and scientific terms used herein have the same meaning as commonly understood by those skilled in the technical field to which the invention belongs. The terms used herein in the specification of the present disclosure are for the purpose of describing specific embodiments only but not intended to limit the present disclosure. The term “or/and” used herein includes any and all combinations of one or more related listed items.

The technical features of the above-described embodiments may be arbitrarily combined. For the sake of brevity of description, all possible combinations of the technical features in the above embodiments are not described. However, as long as there is no contradiction between the combinations of these technical features, all should be considered as the scope of the present description.

The above-described embodiments only show several implementation ways of the present disclosure, which are more specific and detailed, but not to be construed as limiting the scope of the present disclosure. It should be noted that those of ordinary skill in the art may further make variations and improvements without departing from the conception of the invention, and these all fall within the scope of the invention. Therefore, the scope of the invention patent shall be subject to the appended Claims.

What is claimed is:

1. A mixed-anion solid electrolyte, having the following chemical formula: Li_{d}Al_{1-c}Y_{c}Cl₃₋ₐX_{b}, wherein Y is selected from at least one of Si⁴⁺, Ge⁴⁺, Sn⁴⁺, Sb⁵⁺, Nb⁵⁺, Ta⁵⁺, Mo⁶⁺, and W⁶⁺, and X is selected from at least one of O²⁻, S²⁻, F⁻, Br⁻, I⁻, and BH⁴⁻; and wherein 0<d≤2, 0<b≤2, 0<a≤2, 0<c<0.75 and charge balance is reached.

2. The mixed-anion solid electrolyte according to claim 1, wherein the Y is selected from one of Si⁴⁺, Ge⁴⁺, Sn⁴⁺, Sb⁵⁺, Nb⁵⁺, Ta⁵⁺, Mo⁶⁺, and W⁶⁺.

3. The mixed-anion solid electrolyte according to claim 2, wherein the X is selected from one of O²⁻, S²⁻, F⁻, Br⁻, I⁻, and BH⁴⁻.

4. The mixed-anion solid electrolyte according to claim 3, wherein the chemical formula of the mixed-anion solid electrolyte is one of Li_{0.8}AlCl_{2.2}O_{0.8}, LiAlCl₂S_{0.5}O_{0.5}, Li_{0.8}AlCl_{1.8}O_{0.8}Br_{0.4}, Li_{0.8}AlCl_{1.8}O_{0.8}(BH₄)_{0.4}, Li_{0.8}AlCl_{1.8}O_{0.8}F_{0.4}, Li_{0.8}Al_{0.9}Nb_{0.1}Cl₂O, Li_{0.8}Al_{0.9}Ta_{0.1}Cl₂O, Li_{0.7}Al_{0.9}Mo_{0.1}Cl₂O, Li_{0.7}Al_{0.9}W_{0.1}Cl₂O, Li_{0.8}Al_{0.6}Si_{0.4}Cl_{2.2}O, Li_{0.9}Al_{0.9}Ge_{0.1}Cl₂O, and Li_{0.8}Al_{0.6}Nb_{0.2}Ta_{0.2}Cl_{2.2}O_{1.2}.

5. A preparation method of the mixed-anion solid electrolyte according to claim 1, comprising the following steps: in an inert atmosphere, mixing LiCl or LiOH, AlCl₃, a lithium compound containing an X element, an aluminum compound containing an X element, and a chloride of an Y element according to a stoichiometric ratio, and then well grinding the raw materials until no granules are observed; then, performing high-temperature reaction and cooling the reaction product to obtain the mixed-anion solid electrolyte.

6. The preparation method of the mixed-anion solid electrolyte according to claim 5, wherein a temperature rise rate of the high-temperature reaction is within a range of 1° C./min to 5° C./min.

7. The preparation method of the mixed-anion solid electrolyte according to claim 5, wherein a reaction temperature of the high-temperature reaction is within a range of 150° C. to 400° C.

8. The preparation method of the mixed-anion solid electrolyte according to claim 5, wherein a reaction time of the high-temperature reaction is within a range of 0.1 h to 2 h.

9. An use of the mixed-anion solid electrolyte according to claim 1 in a preparation of a lithium-ion battery.

10. An use of the mixed-anion solid electrolyte prepared by the preparation method according to claim 5 in a preparation of a lithium-ion battery.

11. An all-solid-state lithium-ion battery, comprising a solid electrolyte, wherein the solid electrolyte is the mixed-anion solid electrolyte according to claim 1.

12. An all-solid-state lithium-ion battery, comprising a solid electrolyte, wherein the solid electrolyte is the mixed-anion solid electrolyte prepared by the preparation method according to claim 5.
